(19) United States
(12) Patent Application Publication
(10) Pub. No.: US 2021/0289978 A1
(43) Pub. Date: Sep. 23, 2021

(54) REUSABLE FILTER CARTRIDGE

(71) Applicant: Eko Brands, LLC, Woodinville, WA (US)

(72) Inventors: Fritz Kruger, Clyde Hill, WA (US); Jennifer Lemmer, Seattle, WA (US); Tracie Luthi, Seattle, WA (US)

(21) Appl. No.: 16/827,660

(22) Filed: Mar. 23, 2020

(51) Int. Cl. A47J 31/06; B65D 85/804

(52) U.S. Cl. CPC A47J 31/0668; A47J 31/407; B65D 85/8046

(57) ABSTRACT

A beverage brewing device is configured for use with a beverage brewer having an inlet probe for dispensing water and an outlet probe positioned in a holster defining ridges along a sidewall thereof. The beverage brewing device includes a sidewall defining grooves sized and positioned to receive the ridges, the sidewall being conical in shape. A bottom wall extends across a bottom of the sidewall and one or both of the bottom wall and the sidewall define openings covered with filter material. Outlet probe receptacles positioned to receive the outlet probe extend upwardly from the bottom wall.

### FIELD OF THE INVENTION

This application relates to cartridges for holding a brewing medium for use with an automated beverage brewer.

### BACKGROUND OF THE INVENTION

There are numerous devices available today for making a single-serve brewed beverage, such as the single-server brewers shown and described in, for example, U.S. Pat. Nos. 6,708,600, and 6,079,315, the disclosures of which are hereby expressly incorporated by reference herein.

In a typical single-serve beverage brewer, a disposable beverage filter cartridge containing a dry beverage medium (such as tea or coffee) is disposed within a filter cartridge holder or brewing holster. To brew the beverage, the filter cartridge is pierced by inlet and outlet probes to accommodate a through-flow of metered hot water. The hot water infuses the dry beverage medium contained in the cartridge to thereby produce a single serving of the beverage. After the beverage is brewed, the cartridge is removed from the cartridge holder and it is discarded.

By requiring the use of the disposable cartridges, the consumer is limited to the beverage selection of the cartridges on hand. Moreover, with each cartridge being disposed of after use, there is much needless waste. Thus there is a need for a reusable cartridge filter suitable for use with a beverage brewer described above that can be used with any desired dry beverage medium (coffee, tea, etc.).

The apparatus and methods disclosed herein provide an improved approach for preparing brewed beverages using a beverage brewer designed to use disposable cartridges.

### SUMMARY OF THE INVENTION

In one aspect of the invention a beverage brewing device includes a bottom having a bottom perimeter, the bottom having an inner bottom surface and an outer bottom surface opposite the inner bottom surface. The device further includes a sidewall including an inner sidewall surface and an outer sidewall surface, the sidewall extending upwardly and outwardly from the bottom perimeter to an upper rim, the upper rim defining a top opening, the bottom and the sidewall combining to define an interior space. A lid defines an inlet probe opening extending through the lid, the lid being moveable between an open position and a closed position, the lid further being sized to cover the top opening when in the closed position. A first receptacle indentation is positioned at the bottom perimeter and being formed in a portion of the bottom and a portion of the sidewall, the first receptacle indentation extending upwardly from the inner bottom surface and inwardly from the inner sidewall surface, the first receptacle indentation forming a first interior receptacle indentation wall protruding into the interior space and being surrounded by the inner bottom surface and the inner sidewall surface. One or more filter areas are defined in at least one of the sidewall and the bottom. One or more grooves extend inwardly from the outer sidewall surface and extend from the outer bottom surface at least partially toward the top opening. The inner sidewall surface, the first interior receptacle indentation wall, the inner bottom surface, and the one or more filter areas are configured to combine to hold a brewing material when the brewing material is placed in the interior space.

In some embodiments, a depth of the one or more grooves decreases with distance from the outer bottom surface. In some embodiments, the one or more grooves include a plurality of grooves distributed circumferentially around the sidewall. In some embodiments, the plurality of grooves are distributed non-uniformly around the sidewall. In some embodiments, the plurality of grooves include two pairs of grooves such that the grooves of each pair are closer to one another than to all grooves of another pair of the two pairs of grooves. In some embodiments, the one more grooves include two grooves or four grooves.

In some embodiments, first receptacle indentation extends partially toward the center of the bottom surface.

In some embodiments, there is a second receptacle indention positioned at the bottom perimeter and located diametrically opposite the first receptacle indentation, the second receptacle indentation being formed in a portion of the bottom and a portion of the sidewall, the second receptacle indentation extending upwardly from the inner bottom surface and inwardly from the inner sidewall surface, the second receptacle indentation forming a second interior receptacle indentation wall protruding into the interior space and being surrounded by the inner bottom surface and inner sidewall surface.

In some embodiments, the sidewall is integrally formed with the bottom and the first receptacle indentation is integrally formed with the bottom and the sidewall.

In some embodiments, the one or more filter areas are included in the sidewall. In some embodiments, the one or more grooves extend through the one or more filter areas. In some embodiments, the one or more filter areas include mesh extending across openings in at least one of the sidewall and the bottom.

In some embodiments, the inner bottom surface further include a planar portion extending from a first location at the perimeter to a second location at the perimeter, the first location being diametrically opposite the second location.

In another aspect of the invention, a beverage brewing device includes a lid defining an inlet probe opening. The device further has a body including a sidewall having a circular upper rim for engagement with the lid in the closed position, a lower edge defining a lower perimeter, and an inner sidewall surface extending between the upper rim and the lower edge. The body may have a bottom surface having an inner bottom surface and an outer bottom surface opposite the inner bottom surface, the bottom surface extending across the lower perimeter such that the inner bottom surface intersects the inner sidewall surface, the inner sidewall surface and inner bottom surface combining to form an internal volume. In some embodiments, one or more grooves extend inwardly from an outer sidewall surface of the sidewall and extending from the outer bottom surface at least partially toward the circular upper rim. One or more filter areas may be defined in the body. The sidewall, the bottom surface, the receptacle wall, and the one or more filter areas may be configured to, in combination, retain a dry beverage medium within the internal volume. The device is configured such that a liquid is insertable through the central opening of the lid and will flow out of the internal volume through the one or more filter areas.

In some embodiments, a depth of the one or more grooves decreases with distance from the outer bottom surface. In some embodiments, the one or more grooves comprise a plurality of grooves distributed circumferentially around the sidewall. In some embodiments, the plurality of grooves include two pairs of grooves such that the grooves of each pair are closer to one another than to all grooves of another pair of the two pairs of grooves.

In some embodiments, the brewing device includes an outlet probe receptacle extending inwardly from the inner sidewall surface and inwardly into the bottom surface toward a center of the bottom surface, the outlet probe receptacle further having a receptacle wall configured as an indentation extending into the internal volume.

In some embodiments, the one or more filter areas are included in the sidewall, the one or more grooves extending across the one or more filter areas.

### BRIEF DESCRIPTION OF THE DRAWINGS

Preferred and alternative examples of the present invention are described in detail below with reference to the following drawings:

FIG. 1 is an isometric view of a reusable brewing device in accordance with an embodiment of the present invention;

FIG. 2 is a top view of the reusable brewing device of FIG. 1;

FIG. 3 is a bottom isometric view of the reusable brewing device of FIG. 1;

FIGS. 4 and 5 are bottom isometric view of reusable brewing devices with alternative receptacles; and

FIG. 6 is a top isometric view of a brewing holster for use with the reusable brewing device of FIGS. 1 through 5.

### DETAILED DESCRIPTION OF THE PREFERRED EMBODIMENT

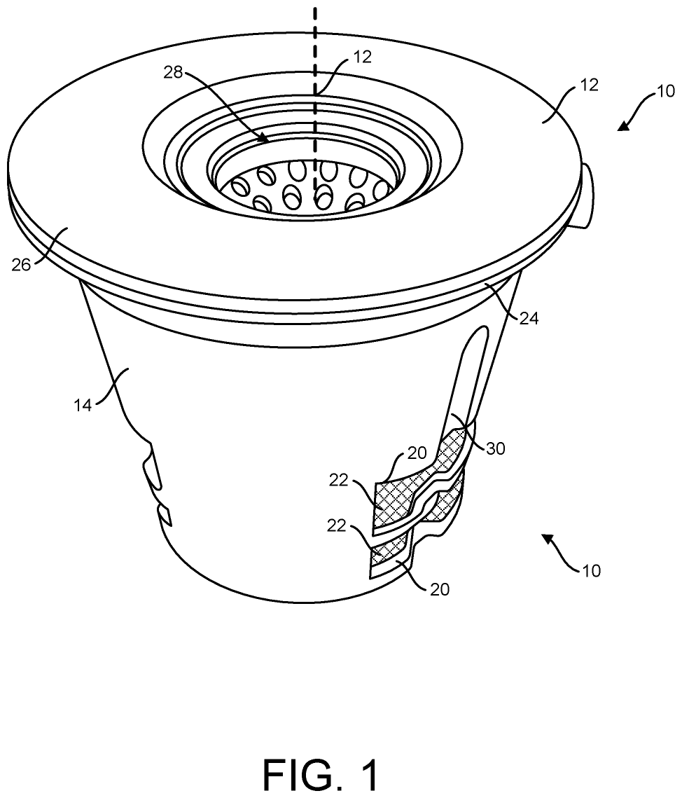

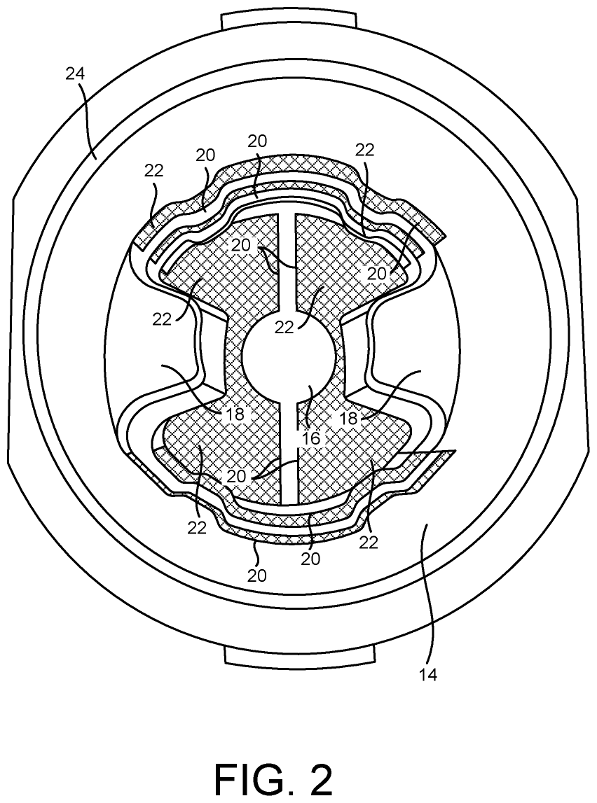

Referring to FIGS. 1, 2 and 3, a base cup 10 may define an axis of symmetry 12 about which a sidewall 14 of the base cup 10 is generally symmetrical with various non-symmetrical features defined thereon. The sidewall 14 has a generally conical shape with a shallow tapering to conform to a cavity of a beverage brewer. A bottom wall 16 extends inwardly from the sidewall 14 such that some or all of the sidewall 14 extends above an upper surface of the bottom wall 16. The bottom wall 16 may define an inner bottom surface and an outer bottom surface that may be planar. The inner bottom surface may include a planar portion extending from a first location at a perimeter of the bottom wall 16 to a second location at the perimeter, the first location being diametrically opposite the second location

One or more outlet probe receptacles 18 protrude inwardly from one or both of the sidewall 14 and the bottom wall 16. In the illustrated embodiment, two outlet probe receptacles 18 protrude upwardly through the bottom wall 16 and are disposed 180 degrees apart about the axis of symmetry 12. The outlet probe receptacles 18 include pockets made of continuous, imperforated, impermeable material (e.g., the same material as the base cup) that isolate the contents of the base cup 10 from an outlet probe protruding into the outlet probe receptacle. In a typical beverage brewer, only one outlet probe is present such that only one receptacle 18 is used in some embodiments. However, providing two receptacles 18 enables the user to position the base cup in two positions without interference from the outlet probe.

In the illustrated embodiment, the receptacles 18 are embodied as indentations positioned at a bottom perimeter of the sidewall and formed by a portion of the bottom wall 16 and a portion of the sidewall. The indentation of each receptacle 18 may extend upwardly from the inner bottom surface of the bottom wall 16 and inwardly from an inner sidewall surface of the sidewall 14. The receptacle 18 may include a first interior receptacle indentation wall protruding into an interior space defined by the sidewall 14 and bottom wall 16 and be surrounded by the inner bottom surface and the inner sidewall surface. As is apparent in FIGS. 1-3, the sidewall 14, bottom wall 16, and receptacles 18 may be integrally formed, e.g., co-molded.

The sidewall 14 and possibly the bottom wall 16 further define one or more filter apertures 20. The filter apertures 20 may be large and occupy a major portion (e.g., between 20 and 50 percent) of the vertical (e.g., parallel to the axis of symmetry 12) and circumferential (e.g., about the axis of symmetry 12) extent of the sidewall 14 between the topmost and bottommost edges thereof.

The filter apertures 20 are completely covered by filter material 22. Any suitable reusable, durable filter may be used, such as a micro-screen mesh filter made from metal (such as gold or stainless steel, gold-tone filters), plastic, or fabric. The filter material 22 may be molded into the material of the sidewall 14 in order to resist separation from the sidewall 14 after repeated use.

An upper rim 24 of the sidewall 14 may include a fastening structure such as threads, a snap-type fitting, or any other type of fastening structure. A lid 26 inserts within the upper rim 24 and defines an inlet probe receptacle 28 for receiving the inlet probe of a brewing device. The lid 24, sidewall 14, and bottom wall 16 define a brewing chamber for holding a dry beverage medium.

An outer surface of the sidewall 14 defines one or more grooves 30, two or more grooves, or four grooves 30 as in the illustrated embodiment. The grooves 30 extend inwardly from the outer surface of the sidewall 14 and may be of sufficient depth that an inner surface of the sidewall 14 protrudes inwardly in the circumferential region occupied by the grooves 30. Alternatively, the sidewall 14 may simply be made thinner to define the grooves 30 without the inner surface thereof protruding inwardly.

The grooves 30 are distributed about the axis of symmetry 12 and extend from the bottom surface of the bottom wall 16 at least partially toward the upper rim 24. In particular, a center line of each groove 30 may extend within a vertical plane intersecting the axis of symmetry 12 and passing through a center of the groove 30. A depth of the groove 30 inward from the outer surface of the sidewall 14 measured in that vertical plane may decreases with distance from the bottom wall 16 along the axis of symmetry 12. In some embodiments, a width of the groove, e.g. a circumferential width at the outer surface of the sidewall 14 also decreases with distance from the bottom wall 16.

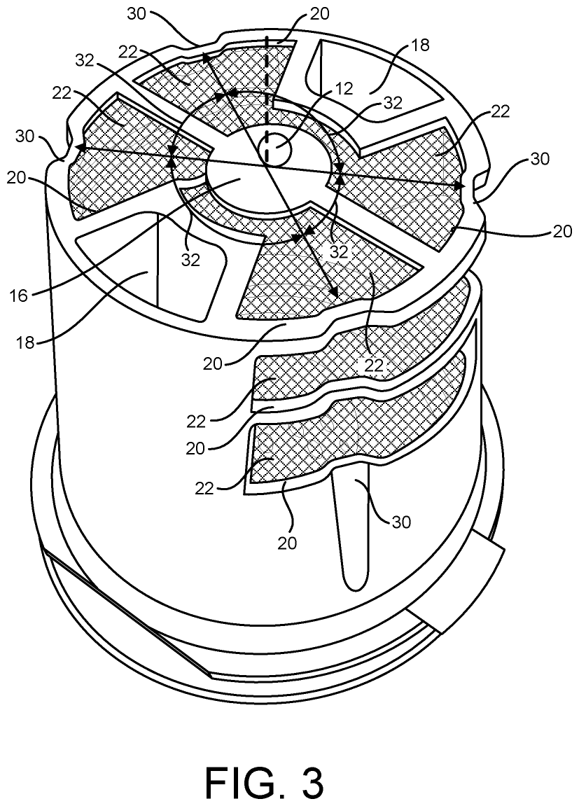

As is best seen in FIG. 3, the grooves 30 may extend across the filter openings 20 in the sidewall 14. The filter material 22 in these openings 20 may also be contoured to conform to the grooves 30, i.e. a portion of the groove 30 may be defined by the filter material 22.

In the illustrated embodiment, the grooves 30 are distributed about the axis of symmetry non-uniformly. for example, each groove 30 may be separated from adjacent grooves 30 by angles 32. The grooves 30 may include two pairs of grooves 30 such that for each pair of grooves 30, the separation angle 32 between the grooves 30 of that pair is less (e.g., 30 percent less, preferably 50 percent less) than the separation angle 32 of these grooves 30 relative to the grooves 30 of the other pair.

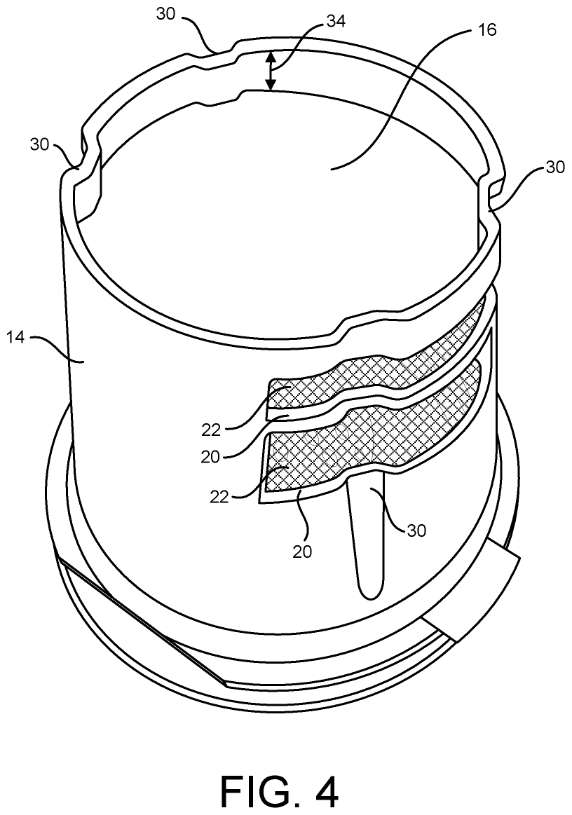

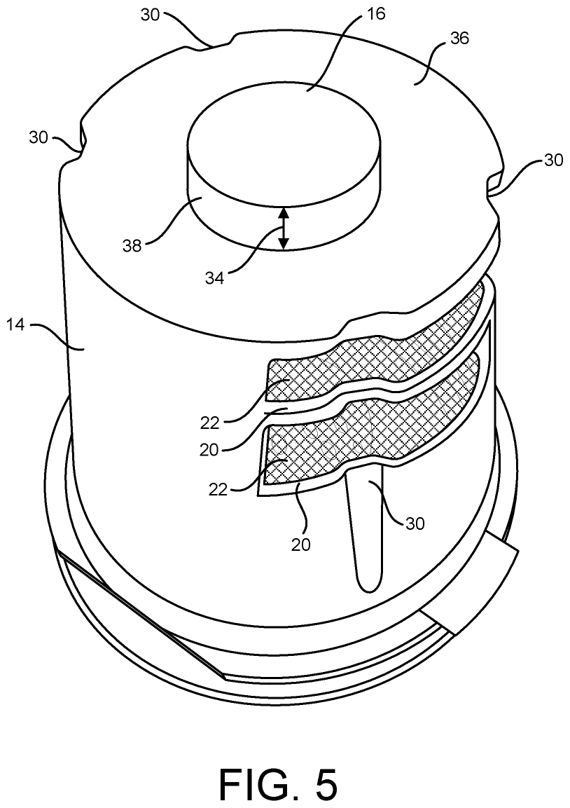

FIGS. 4 and 5 illustrate alternative approaches for providing clearance for an outlet probe. In the embodiment of FIG. 4, the bottom wall 16 is recessed above the bottom edge of the sidewall 14 by a distance 34. This provides a space below the bottom wall 16 to receive the outlet probe. The distance 34 may therefore be selected to be a vertical distance between the surface on which the edges of the sidewall 14 rest during brewing and a top of the outlet probe plus some tolerance, e.g., 1 to 2 mm. The tolerance may increase or decrease based on the product configuration desired. For example, a greater tolerance may be used if a smaller interior volume of the cup 10 is desired or acceptable. On the other hand, a smaller tolerance may be used if a larger interior volume of the cup 10 is desired or acceptable.

In the embodiment of FIG. 5, the bottom wall 16 protrudes below an intermediate wall 36 that extends between the perimeter of the sidewall 14 and the bottom wall 16 and may be parallel to the bottom wall 16 and both walls 16, 36 may be planar or planar over a majority of their surfaces. The distance perpendicular to the axis of symmetry of the sidewall 14 between the edge of the bottom wall 16 and the edge of the perimeter of the sidewall 14 is such that the outlet probe there is space of the outlet probe in the annular region around the bottom wall 16. As shown, a cylindrical wall 38 may extend between the bottom wall 16 and the intermediate wall 36. The distance 34 between the intermediate wall 36 and the bottom wall 16 may be such that it provides clearance for the outlet probe: equal to a vertical distance from the surface on which the bottom wall 16 rests and a top of the outlet probe plus a tolerance, e.g., 1 to 2 mm. As noted above, the tolerance may increase or decrease based on the product configures desired.

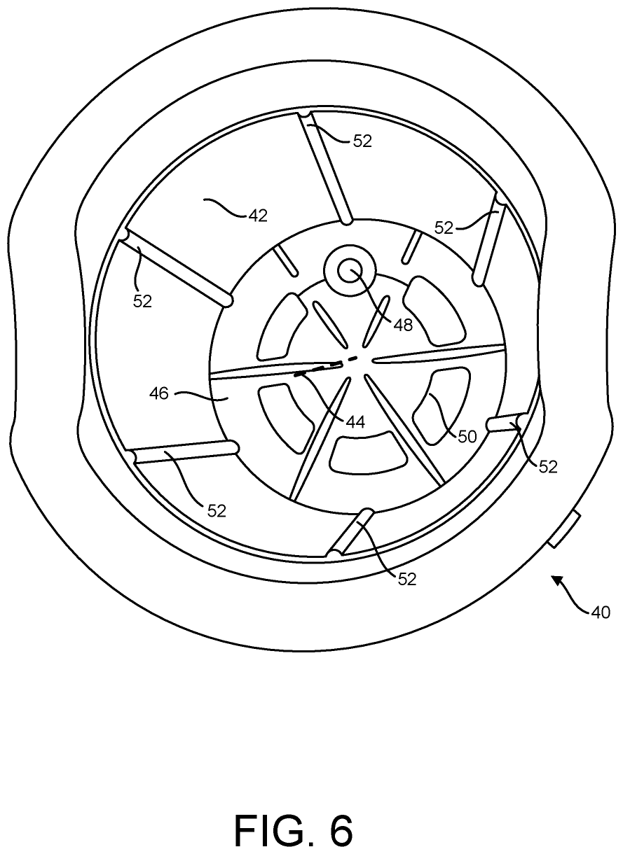

FIG. 6 illustrates a brewing holster 40 including a sidewall 42 defining an axis of symmetry 44. The sidewall 42 may correspond to the size of the sidewall 14 only larger in order to receive the cup 10 freely, i.e. without requiring deformation of the cup 10 or having a friction or interference fit with the cup 10. In the illustrated embodiment, the sidewall 42 has a generally conical shape defined about an axis of symmetry 44. The flare or cone angle of the conical shape may be the same as that of the sidewall 14.

A bottom wall 46 extends across the bottom of the sidewall and has an outlet probe 48 protruding upwardly therefrom. The outlet probe 48 is positioned such that when the cup 10 is positioned within the holster 40, the cup 10 may be oriented having the probe 48 extending above the bottom wall 16 of the cup 10 and into one of the receptacles 18. The distance between the bottom wall 46 and the top of the outlet probe 48 along the axis of symmetry 44 is less than a depth of the receptacles 18 for the embodiments of FIGS. 1 through 3 or the distance 34 for the embodiments of FIGS. 4 and 5. The bottom wall 46 further defines openings 50. In use, water or steam is emitted through an inlet probe into the opening 28 in the lid 26. The water or steam releases matter from a brewing material positioned within the cup 10 to obtain a brew. The brew then flows out through the filter material 22 and out of the outlet probe 48.

The sidewall 42 may include ridges 52 protruding outwardly therefrom and corresponding in size and circumferential position to the position of the grooves 30 on the sidewall 14. In particular, for each receptacle 18 there is a position such that the outlet probe 48 protrudes into the receptacle 18 and the ridges 52 insert within the grooves 30.

As for the grooves 30, the ridges 52 extend along the sidewall 42 such that a center of the ridges 52 lies on a vertical plane intersecting the axis of symmetry 44. The depth and circumferential width of the grooves 30 may be such that the ridges 52 slide freely within the grooves without deformation of the grooves 30 or ridges 52, i.e. when the ridges 52 are aligned with the grooves 30 there no friction fit or interference fit between the ridges 52 and the grooves 30.

As is apparent in FIG. 6, there are six ridges 52 as compared to the four grooves 30. In some embodiments, any four of the ridges 52 may nest within the grooves 30, provided clearance is provided for the outlet probe 48. The use of fewer grooves than there are ridges 52 facilitates insertion of the cup 10 while reducing the amount of interior volume of the cup 10 that is lost due to inward protrusion of the grooves. In an alternative embodiment, the brewing holster may include fewer or more ridges in different placements, and the number and location of grooves 30 may be adjusted to facilitate both the desired fit between the cup and the holster and the desired volume of the cup.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A beverage brewing device comprising:
a bottom having a bottom perimeter, the bottom having an inner bottom surface and an outer bottom surface opposite the inner bottom surface;
a sidewall including an inner sidewall surface and an outer sidewall surface, the sidewall extending upwardly and outwardly from the bottom perimeter to an upper rim, the upper rim defining a top opening, the bottom and the sidewall combining to define an interior space;
a lid defining an inlet probe opening extending through the lid, the lid being moveable between an open position and a closed position, the lid further being sized to cover the top opening when in the closed position;
a first receptacle indentation positioned at the bottom perimeter and being formed in a portion of the bottom and a portion of the sidewall, the first receptacle indentation extending upwardly from the inner bottom surface and inwardly from the inner sidewall surface, the first receptacle indentation forming a first interior receptacle indentation wall protruding into the interior space and being surrounded by the inner bottom surface and the inner sidewall surface;
one or more filter areas defined in at least one of the sidewall and the bottom; and
one or more grooves extending inwardly from the outer sidewall surface and extending from the outer bottom surface at least partially toward the top opening;
wherein the inner sidewall surface, the first interior receptacle indentation wall, the inner bottom surface, and the one or more filter areas are configured to combine to hold a brewing material when the brewing material is placed in the interior space.

2. The beverage brewing device of claim 1, wherein a depth of the one or more grooves decreases with distance from the outer bottom surface.

3. The beverage brewing device of claim 1, wherein the one or more grooves comprise a plurality of grooves distributed circumferentially around the sidewall.

4. The beverage brewing device of claim 3, wherein the plurality of grooves are distributed non-uniformly around the sidewall.

5. The beverage brewing device of claim 4, wherein the plurality of grooves include two pairs of grooves such that the grooves of each pair are closer to one another than to all grooves of another pair of the two pairs of grooves.

6. The beverage brewing device of claim 3, wherein the one or more grooves include two grooves.

7. The beverage brewing device of claim 3, wherein the one or more grooves include exactly four grooves.

8. The beverage brewing device of claim 1, wherein the first receptacle indentation extends partially toward the center of the bottom surface.

9. The beverage brewing device of claim 1, further comprising a second receptacle indention positioned at the bottom perimeter and located diametrically opposite the first receptacle indentation, the second receptacle indentation being formed in a portion of the bottom and a portion of the sidewall, the second receptacle indentation extending upwardly from the inner bottom surface and inwardly from the inner sidewall surface, the second receptacle indentation forming a second interior receptacle indentation wall protruding into the interior space and being surrounded by the inner bottom surface and inner sidewall surface.

10. The beverage brewing device of claim 1, wherein the sidewall is integrally formed with the bottom and the first receptacle indentation is integrally formed with the bottom and the sidewall.

11. The beverage brewing device of claim 1, wherein the one or more filter areas are included in the sidewall.

12. The beverage brewing device of claim 11, wherein the one or more grooves extend through the one or more filter areas.

13. The beverage brewing device of claim 1, wherein the one or more filter areas include mesh secured across openings in at least one of the sidewall and the bottom.

14. The beverage brewing device of claim 1, wherein the inner bottom surface further comprises a planar portion extending from a first location at the perimeter to a second location at the perimeter, the first location being diametrically opposite the second location.

15. A beverage brewing device comprising:
a lid defining an inlet probe opening;
a body comprising:
a sidewall having a circular upper rim for engagement with the lid in the closed position, a lower edge defining a lower perimeter, and an inner sidewall surface extending between the upper rim and the lower edge;
a bottom surface having an inner bottom surface and an outer bottom surface opposite the inner bottom surface, the bottom surface extending across the lower perimeter such that the inner bottom surface intersects the inner sidewall surface, the inner sidewall surface and inner bottom surface combining to form an internal volume; and
one or more grooves extending inwardly from an outer sidewall surface of the sidewall and extending from the outer bottom surface at least partially toward the circular upper rim;
one or more filter areas defined in the body;
wherein the sidewall, the bottom surface, the receptacle wall, and the one or more filter areas are configured to, in combination, retain a dry beverage medium within the internal volume; and
whereby a liquid is insertable through the central opening of the lid and will flow out of the internal volume through the one or more filter areas.

16. The beverage brewing device of claim 15, wherein a depth of the one or more grooves decreases with distance from the outer bottom surface.

17. The beverage brewing device of claim 15, wherein the one or more grooves comprise a plurality of grooves distributed circumferentially around the sidewall.

18. The beverage brewing device of claim 17, wherein the plurality of grooves includes two pairs of grooves such that the grooves of each pair are closer to one another than to all grooves of another pair of the two pairs of grooves.

19. The beverage brewing device of claim 15, further comprising an outlet probe receptacle extending inwardly from the inner sidewall surface and inwardly into the bottom surface toward a center of the bottom surface, the outlet probe receptacle further having a receptacle wall configured as an indentation extending into the internal volume.

20. The beverage brewing device of claim 15, wherein the one or more filter areas are included in the sidewall, the one or more grooves extending across the one or more filter areas.
